(19) United States
(12) Patent Application Publication
(10) Pub. No.: US 2022/0397465 A1
(43) Pub. Date: Dec. 15, 2022

(54) PRESSURE GAUGE PORTABLE RAM KIT

(71) Applicant: VIS, LLC, GREER, SC (US)

(72) Inventor: ROBERT FOX, GREENVILLE, SC (US)

(73) Assignee: VIS, LLC, GREER, SC (US)

(21) Appl. No.: 17/344,310

(22) Filed: Jun. 10, 2021

(51) Int. Cl. G01L 1/02; G01L 5/00

(52) U.S. Cl. CPC G01L 1/02; G01L 5/0038

(57) ABSTRACT

A force gauge is described having a plurality of scales to facilitate use of different force rated hydraulic tools.

This application relates to the general subject matter of U.S. Application Ser. No. 16/700,231, filed on Dec. 2, 2019 and Design Serial No. 29/710,909 filed on Oct. 28, 2019, both of which are incorporated herein by reference.

### FIELD OF THE INVENTION

This invention relates to portable ram kits and more particularly to a force gauge for use with a two-speed hand pump for a portable ram kit. The force gauge may also be used with other hydraulic products having attachments that operate over a broad range of forces.

### BACKGROUND OF THE INVENTION

This invention relates to hydraulic portable ram kits that are frequently used for automotive body, fender, and frame repair and have other applications in various industrial and maintenance industries. Typically, popular kit operating capacities include ½, 4, 10 & 20 ton capacity rams that may use a manually operable pump or an air/hydraulic foot pump to transfer hydraulic fluid through a supply hose that is connected to a ram. Typical components within a hydraulic ram kit may include various sizes and capacities of rams, extension tubes, and adapters.

One problem with various kits is that the interchangeable components within a kit may be rated at lower capacities than the kit itself. As such, if a 4 ton ram, having a small inside cylinder diameter, is used with a 10 ton pump, the 10 ton pump gauge dial display cannot be accurately read. In this instance the user cannot tell by looking at the gauge if the 4 ton ram is being used beyond its rated capacity. Using a 10 ton pump to activate a 4 ton ram can easily result in a broken or damaged 4 ton ram.

Accordingly, there remains room for improvement and variation within the art.

### SUMMARY OF THE INVENTION

It is one aspect of at least one of the present embodiments to provide a pump gauge for measuring force comprising: a dial face; an indicator needle positioned above the dial face and responsive to a hydraulic pressure flowing through the gauge which corresponds to force readings on the dial; a first measuring scale; a second measuring scale; a third measuring scale; wherein the first, second, and third measuring scales each reflect a different force range.

It is one aspect of at least one of the present embodiments to provide a process of using a hydraulic pump comprising the steps of supplying a hydraulic pump, the pump having a gauge for measuring tons of force comprising:

a dial face; an indicator needle positioned above the dial face and responsive to a hydraulic pressure flowing through the gauge which corresponds to force readings on the dial; a first measuring scale; a second measuring scale; a third measuring scale; wherein the first, second, and third measuring scales each reflect a different force range; selecting a ram to be used with the hydraulic pump; determining the rated capacity of the ram to be used with the hydraulic pump; selecting a corresponding measuring scale from the first measuring scale, the second measuring scale, and the third measuring scale; operating the pump using the corresponding measuring scale to permit safe operation of the pump, ram and components to avoid an excess force; and releasing the ram force wherein the indicator needle is positioned at “0” when the force is fully released.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a diagram of one non-limiting embodiment of a 4 ton pump gauge illustration.

FIG. 2 is a non-limiting embodiment of a 10 ton pump gauge illustration.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5. As used herein, the term “effective amount” means a value of plus or minus 10 percent of the stated value unless a different specific value or range is provided.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

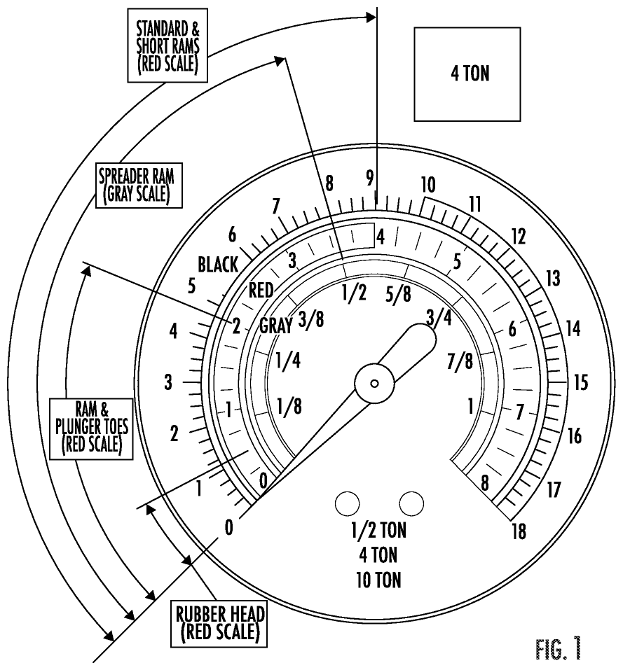

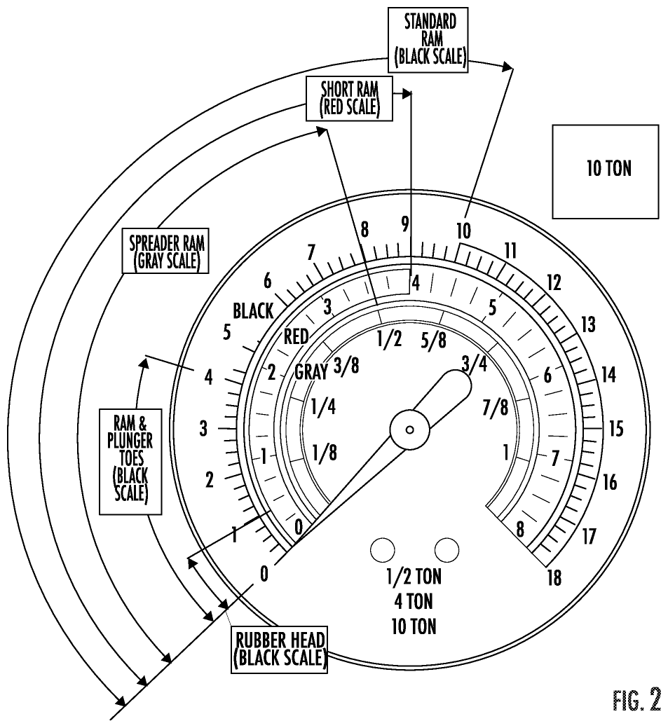

As set forth in FIGS. 1 and 2 are gauges that are designed for a wide range of forces. With respect to FIGS. 1 and 2, the gauge faces are identical. However, set forth in FIG. 1 is an illustration of the portions of gauge a user would use with a 4 ton pump. FIG. 2 is the same gauge face but highlights the portions of the gauge that would be used by the operator of a 10 ton pump.

The gauge face illustrated in FIG. 1 and FIG. 2 includes markings to distinguish between a 10 ton, a 4 ton, and a ½ ton as reflected by numeral references 20, 18 and 16 on the dial face to indicate which of the respective force indicators should be read.

In use, a technician may identify the rated capacity of the rams and components utilized in a specific kit. For instance, using a 4 ton ram, the user should utilize the appropriate markings for the 4 ton capacity as reflected on the register of the gauge. As illustrated, the gauge registers in FIGS. 1 and 2 are marked for ½ ton, 4 ton, and 10 ton ratings. The dial displays values of higher pressures as a visual warning that excessive pressure is being applied.

When properly utilized, the technician verifies the rated capacity of the ram and attachments. When utilized with a two-speed pump, the first pump speed will rapidly extend the ram to an initial load. Once the ram reaches the load, there will be a drop in hand pump effort indicating the pump is transitioning from the first speed to the second speed, the second speed providing easier pumping at maximum rated capacities.

The operator verifies the proper tonnage and then monitors the appropriate portion of the gauge which is reflective of the rated tonnage capacity. As seen, various shadings and/or colors can be utilized to distinguish between three or more-gauge values more readily. If desired, specifically designed components may be marked with appropriate colors or shading to indicate the portion of the gauge that should be utilized. For instance, based upon the sample gauge face in FIGS. 1 and 2 the components having different force ratings may be color-coded to match the appropriate gauge scale.

The user is interested in the force generated at the end of the ram. Accordingly, the gauge reads tons of force instead of internal working pressure of the pump and allows for multiple force scales to be placed on the gauge dial.

While preferred embodiments illustrate a gauge register having three different load values, it is within the scope of the present invention that more than three load values can be utilized and the engaged registers may be modified as otherwise known in the art to include alternative units of measure or to incorporate LED displays or other electronic displays of force values.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. The present description and figures support claims of varying scope including the use of claim language using “comprising”, “consisting of” and “consisting essentially of”. In addition, it should be understood that aspects of the various embodiments may be interchanged, both in whole, or in part. Therefore, the spirit and scope of the appended claims should not be limited to the description of the preferred versions contained therein.

That which is claimed:

1. A gauge for measuring tons of force comprising:
a dial face;
an indicator needle positioned above the dial face and responsive to a hydraulic pressure flowing through the gauge which corresponds to force readings on the dial;
a first measuring scale;
a second measuring scale;
a third measuring scale;
wherein the first, second, and third measuring scales each reflect a different force range.

2. A process of using a hydraulic pump comprising the steps of:
supplying a hydraulic pump, the pump having a gauge for measuring tons of force comprising:
a dial face;
an indicator needle positioned above the dial face and responsive to a hydraulic pressure flowing through the gauge which corresponds to force readings on the dial;
a first measuring scale;
a second measuring scale;
a third measuring scale;
wherein the first, second, and third measuring scales each reflect a different force range;
selecting a ram to be used with the hydraulic pump;
determining the rated capacity of the ram to be used with the hydraulic pump;
selecting a corresponding measuring scale from the first measuring scale, the second measuring scale, and the third measuring scale;
operating the pump using the corresponding measuring scale to permit safe operation of the pump and component combination to avoid an excess pressure; and
releasing the ram force wherein the indicator needle is positioned at “0” indicating the force is fully released.
